(19) United States
(12) Patent Application Publication
(10) Pub. No.: US 2015/0227461 A1
(43) Pub. Date: Aug. 13, 2015

(54) REPAIRING A MEMORY DEVICE

(71) Applicant: Hewlett-Packard Development Company, LP., Houston, TX (US)

(72) Inventors: Melvin K. Benedict, Houston, TX (US); Eric L. Pope, Houston, TX (US); Reza M. Bacchus, Houston, TX (US); Guy E. McSwain, Houston, TX (US); Joseph W. Fahy, Houston, TX (US)

(21) Appl. No.: 14/425,247

(22) PCT Filed: Oct. 31, 2012
(86) PCT No.: PCT/US2012/062743

§ 371 Date: Mar. 2, 2015

(51) Int. Cl. G06F 12/06

(52) U.S. Cl. CPC G06F 12/0646; G06F 2212/1032

(57) ABSTRACT

A technique includes during in-service use of a memory package in a computer system, using a first interface to access a defective address memory of the memory package. The defective address memory is accessible by a manufacturer of the memory package prior to the in-service use using a second interface of the memory package other than the first interface. In connection with the in-service use of the memory package, the memory package is repair, a repair that includes storing a defective address in the defective address memory to change an address mapping for at least one cell of the storage array.

### BACKGROUND

Semiconductor memory devices typically are used in a computer system for purposes of storing data related to the various operations of the system. The memory device may be packaged as a unit in a semiconductor package to form a “memory chip,” and several such chips may be assembled together in the form of a module (a dual inline memory module (DIMM), for example), such that several modules may form, for example, the system memory of the computer system. In general, for purposes of accessing a particular memory device, control, data and address signals are provided to the external terminals of the device and are generated by a memory controller of the computer system.

As an example, one type of memory device is a synchronous dynamic random access memory (SDRAM), which responds to control, data and address signals that are signals synchronized to a clock signal. In this regard, for an SDRAM memory device, data signals are communicated to and from the device using positive going and/or negative going slopes of the clock signal. For a single data rate SDRAM, the data may be clocked once every cycle of the clock signal. For a double data rate (DDR) SDRAM memory device, data may be clocked on both the positive going and negative going edges of the clock signal, thereby giving rise to twice the data rate relative to the single rate SDRAM.

### BRIEF DESCRIPTION OF THE DRAWINGS

FIG. 1 is a schematic diagram of a computer system according to an example implementation.

FIGS. 2 and 6 are flow diagrams depicting techniques to repair a semiconductor memory device according to example implementations.

FIG. 3 is an illustration of an architecture for repairing a semiconductor memory device after the device has been placed in-service in a computer system according to an example implementation.

FIG. 4 is a schematic diagram of a semiconductor memory device according to an example implementation.

FIG. 5 is a schematic diagram of a memory repair service register and logic unit of the semiconductor memory device of FIG. 4 according to an example implementation.

### DETAILED DESCRIPTION

Techniques and systems are disclosed herein for purposes of repairing a semiconductor memory device (a double data rate (DDR) synchronous dynamic random access memory (SDRAM) disposed inside a semiconductor package, for example) after the device has been placed into service (herein called being placed “in-service”) in a computer system. In this regard, although a manufacturer of the memory device may perform various tests on the device and may perform repairs prior to the device being sold and placed in-service, one or more memory cells of the device may subsequently become defective, and/or defective cells may be undetected by the manufacturer. Thus, during the course of using a particular memory device, a computer system may determine that one or more memory cells of a particular row or column are defective.

As disclosed herein, the memory device may be accessed in-service by a processor of the computer system for purposes of performing an in-service repair to remap a row or column containing the defective cell(s) to a spare row or column inside the memory device so that the remapped memory location may be subsequently accessed by components of the system without knowledge of the remapping (i.e., the address used to access the spare cell(s) is the same address of the defective cell(s)). Moreover, as disclosed herein, the spare row/column remapping circuitry of the memory device may be the same circuitry that is accessible by the manufacturer of the memory device (via a test port, for example) before the memory device is placed in-service. Thus, using the memory device's internal spare row/column remapping circuitry, the memory device may be repaired both and before and after the device has been placed in-service in the computer system.

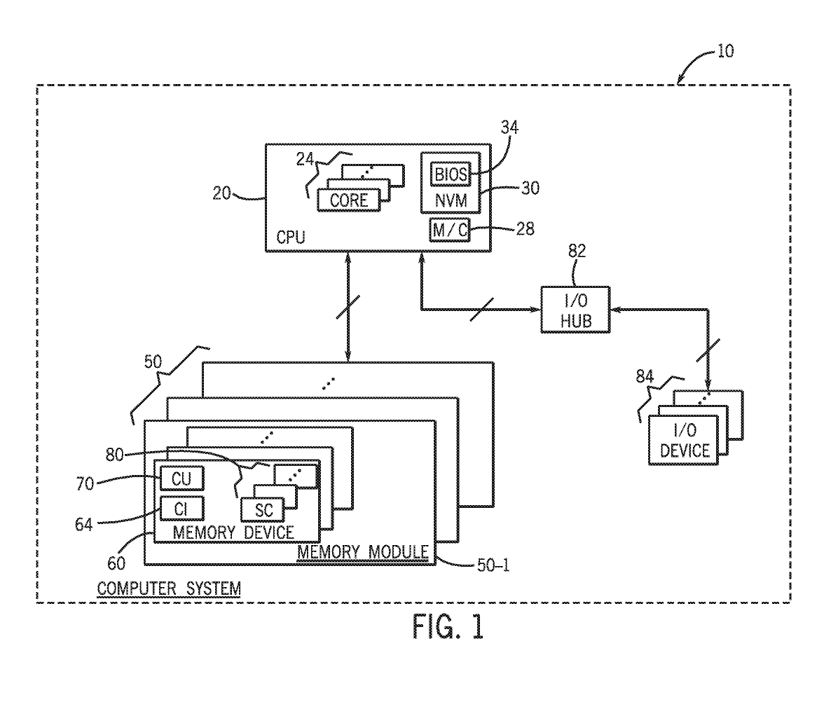

As a more specific example, FIG. 1 depicts a computer system 10 in accordance with an example implementation. In general, the computer system 10 is a physical machine that is made up of actual hardware and software (i.e., machine executable instructions). In this regard, the computer system 10 includes one or multiple central processing units (CPUs) 20 (one CPU 20 being shown in FIG. 1); and each CPU 20 may include one or multiple processing cores 24.

In this regard, the CPU 20 may be packaged inside a particular semiconductor package, which is constructed to be mechanically and electrically mounted to a motherboard of the computer system 10 via an associated connector, or socket. In this manner, the socket is constructed to receive at least a portion of the semiconductor package, which contains the package's electrical contacts, and the socket has mechanical features to secure the semiconductor package to the socket. As a more specific example, in accordance with example implementations, the CPU 20 may be contained in a surface mount package, which has a land grid array (LGA) for purposes of forming electrical connections with corresponding pins of the receiving socket. Other semiconductor packages may be employed, in accordance with further implementations.

As noted above, the CPU 20 contains one or multiple processing cores 24, i.e., processing cores that are constructed to execute machine executable instructions, such as (as examples) microcode; firmware, such as a Basic Input/Output System (BIOS), for example; application instructions; operating system instructions; and so forth. For the example of FIG. 1, the CPU 20 contains multiple processing cores 24. Moreover, in accordance with example implementations, the computer system 10 employs a non-uniform memory architecture (NUMA) in which each CPU 20 includes a memory controller 28 for purposes of reading data from and writing data to memory of the computer system 10.

For the specific example that is shown in FIG. 1, the memory controller 28 of the CPU 20 may access one or multiple memory modules 50 (multiple memory modules 50 being depicted in FIG. 1 for example), and each memory module 50 may include one or multiple semiconductor memory devices 60. As an example, a given memory device 60 may be a double data rate (DDR) synchronous dynamic random access memory (SDRAM) device, in accordance with example implementations.

As depicted by exemplary memory device 60-1 of FIG. 1, the memory device 60 may include one or multiple spare memory cells 80, which allow circuitry inside the memory device 60 to swap defective cell(s) of the memory device 60-1 with the spare memory cell(s) 80 for purposes of effectively replacing a defective memory cell or cells to repair the memory device 60. In this regard, the memory device 60 may include at least one additional spare row and/or column in addition to the rows and columns, which store the data in the memory package's main memory cell array. During testing of the memory device 60 by the manufacturer before the memory device 60 is placed in-service, the manufacturer may determine, through its test equipment, that a particular cell or cells of the device 60 are defective. Upon this occurrence, the manufacturer may use a test port, or configuration interface 64, of the memory device 60, for purposes of programming the memory device 60 to internally remap the column or row containing the defective cell(s) to a spare row or column so that a memory operation that has an address that targets a defective row or column is routed to the replacement row or column, which now is substituted for that address. With the remapping being internal to the memory device 60, components of the computer system 10, in general, outside the memory device 60 are unaware this repair of the memory device 60.

Likewise, after the semiconductor memory device 60 has been placed in-service and thus, has been installed in the computer system 10, as depicted in FIG. 1, the CPU 20 may identify a particular cell or cells of the memory device 60 as being defective. In this manner, although the computer system 10 may employ error code correction (ECC)-based correction and detection, the CPU 20 may, through the execution of the basic input/output system (BIOS) 34 (for example) deem that a particular cell or cells of the memory device 60 are defective. The labeling of a particular memory cell as being defective may be the result, for example, of repeatable errors occurring with the same cell and/or a specific test performed by the CPU 20 under the direction of the BIOS 34 to identify defective cells. Upon identifying one or multiple defective cell(s), the CPU 20 may access the same spare cells 80 internal remapping circuitry, as available to the manufacturer, for purposes of repairing the memory device 60.

In this regard, as disclosed herein, the memory device 60 contains a control unit 70, which may be accessed by the CPU 20 for purposes of repairing the semiconductor memory device 60. In accordance with example implementations, the control unit 70 is the same unit used to receive commands communicated to the memory device 60 during its in-service normal use for purposes of writing data to and reading data from its main storage array(s) or banks. However, when the control unit 70 recognizes a designated in-service repair command, the control unit 70 stores an accompanying address (which accompanies the command in the same bus operation) as the address of a defective row or column. Using this address, the memory device 60 may then remap the defective row or column to a spare row or column using the same spare replacement circuitry used by the manufacturer for in-service repair so that bus operations that target the defective row or column now target the replacement, spare row or column.

Among its other features, the computer system 10 may include various other software and hardware devices, including some that are not shown in FIG. 1. In this regard, FIG. 1 is merely a simplified representation of the computer system 10 to illustrate aspects of the computer system 10 used to repair a semiconductor memory device, such as the example memory device 60-1. The computer system 10 may have various other devices, such as, for example, input/output (I/O) devices 84, which are accessible by the CPU 20 through an I/O hub 82; a non-volatile memory 30; which stores machine executable instructions to form the BIOS 34; additional CPUs 20; additional memory modules 50 associated with the different CPUs 20; graphics controllers; network interfaces; and so forth. Thus, many variations are contemplated, which are within the scope of the appended claims.

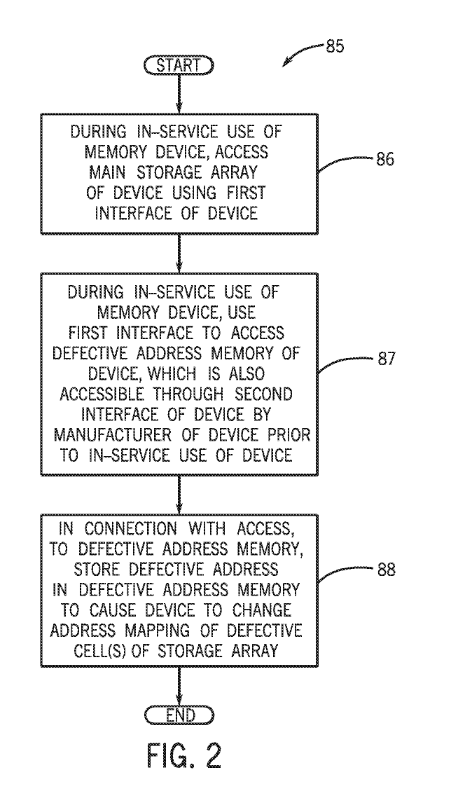

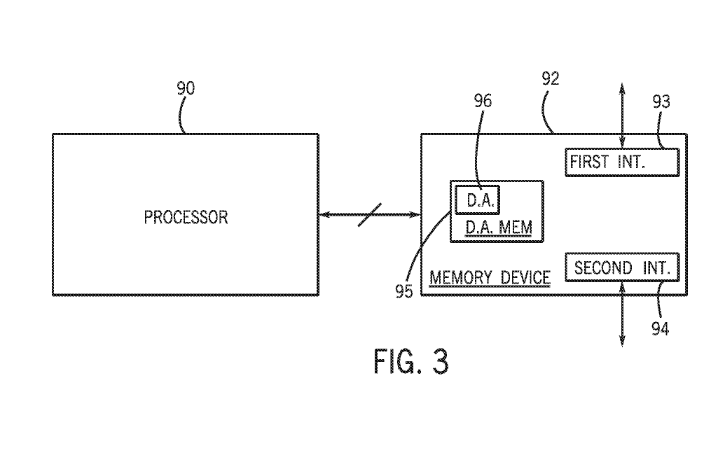

Thus, referring to FIG. 2 in conjunction with FIG. 3, in accordance with an example implementation, a technique 85 (FIG. 2) may be used by a processor 90 (FIG. 3) for purposes of repairing a memory device 92 (see FIG. 3). The processor 90 represents a processing entity, such as one or more CPUs, or one or more processing cores. Pursuant to the technique 85, during in-service use of the memory device 92, the processor 90 may access (block 86) a main storage array of the device 92 using a first interface 93 of the package 92. During the in-service use of the memory package, the processor 90 may use the first interface to access a defective address memory 95 (a register, for example) of the memory device 92, which is also accessible through a second interface 94 by a manufacturer of the memory device 92 prior to the in-service use of the memory device 92, pursuant to block 87. In connection with the in-service access, the processor 90 stores (block 88) a defective address 96 in the defective address memory 95 to cause the memory device 92 to change the address mapping to one or more cell(s) of the storage array, pursuant to block 88, i.e., remap the defective cell(s) to spare cell(s).

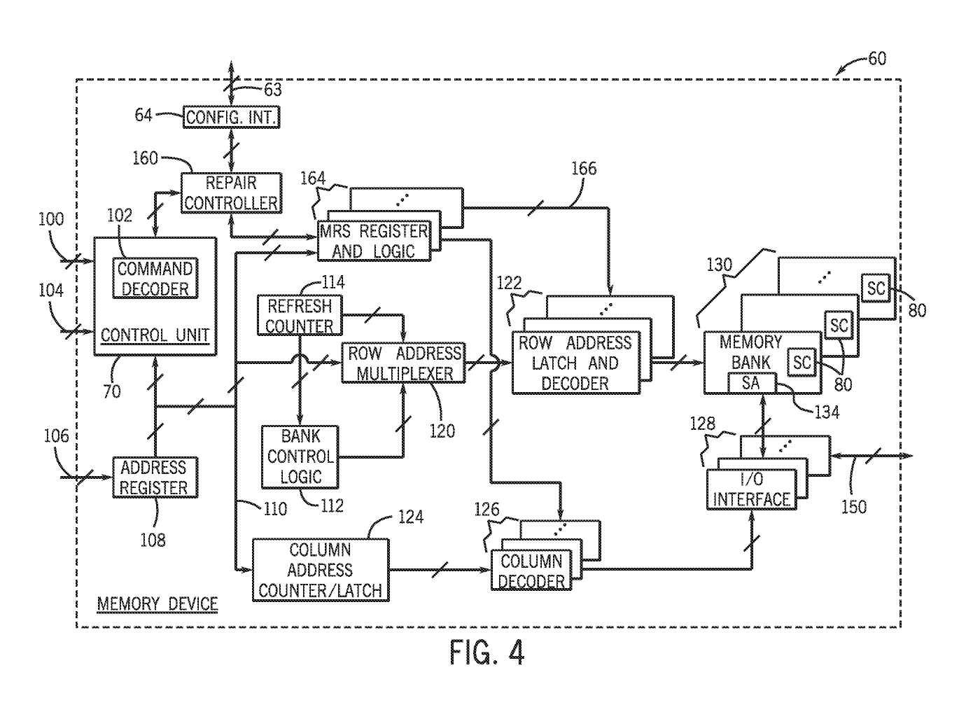

Referring to FIG. 4, in accordance with an example implementation, the memory device 60 includes one or multiple memory banks 130 which include memory cells from the main storage array(s) for the device 60. In addition to having a main memory cell array, each memory bank 130 includes a set of one or multiple spare cells 80, which may be used for purposes of repairing a defective cell or cells of the main array. For example, in accordance with an example implementation, the spare cells 80 for a given memory bank 130 include a set of spare rows such that a spare row may be remapped to replace a given main memory array row containing one or more defective cells. Alternatively, in accordance with further implementations, the spare cells 80 for a given memory bank 130 may include a set of spare columns, which may be remapped to replace one or more columns of the bank 130 containing defective cells. In yet further implementations, the spare cells 80 may include a combination of spare rows and spare columns to replace corresponding rows and columns of the main memory array of the memory bank 130. Thus, many variations are contemplated, which are within the scope of the appended claims.

In addition to the spare cell(s) 80 and the main memory array, the memory bank 130 may contain sense amplifiers 134 for purposes of generating the signals to store data in and retrieve data from the cells of the bank 130. In this regard, the sense amplifiers 134 may be coupled through an input/output (I/O) interface 128 (one I/O interface 128 per memory bank 130) to associated I/O lines 150 of the memory device 60.

As depicted in FIG. 4, the control unit 70 of the memory device 60 includes a command decoder 102, which decodes commands that are communicated to the control unit 70 via a memory bus from the memory controller 28 (see FIG. 1). In general, the command decoder 102 communicates with bus lines 100, which correspond to control signals that indicate the encoded commands. These commands include, for example, write commands, read commands, burst write and read commands, and so forth.

Moreover, the commands include at least one repair command that is directed to repairing the memory device 60. In this regard, in accordance with example implementations, a particular command may be communicated via the control signal bus lines 100 for purposes of directing the memory package 60 to recognize the accompanying address (indicated via bus address lines 106) as being the address identified as a defective row or column address. Upon receiving such command, the memory device 60 internally remaps the defective memory location to a spare row or column to repair the device 60.

In further implementations, the repair command set may include a query command to determine whether a spare row or column is available, a register read command to read the contents of a particular MRS register (described below); and so forth. Thus, many variations are contemplated, which are within the scope of the appended claims.

In accordance with example implementations, the memory device 60 includes a repair controller 160, which responds to a repair command generated by the control unit 70 in response to receiving a repair command via the control signal bus lines 100. For example, in accordance with some implementations, in response to receiving a repair command, the repair controller 160 stores an accompanying defective address location in a corresponding memory repair service (MRS) register and logic 164. In accordance with example implementations, the semiconductor memory device 60 includes at least one MRS register and logic 164 per memory bank 130, although the memory device 60 may include multiple MRS register and logic units 164 per memory bank 130, in accordance with further implementations. When the corresponding MRS register stores a defective address, the memory device 160 monitors incoming addresses and makes comparisons with the stored defective address. When an address match occurs, the MRS register and logic 164 selects the spare row or column accordingly, in lieu of the addressed location (as indicated by the address that is provided to the memory device 60).

As depicted in FIG. 4, in accordance with example implementations, in addition to being accessible through the control unit 70, the repair controller 160 may be accessed through a manufacturer-accessible port, or configuration interface 64, via external terminals 63 of the memory device 60. In this regard, before the memory device 60 is placed in-service, the manufacturer may perform various tests on the package 60 and should a defective memory location be identified, the manufacturer may use the configuration interface 64, for purposes of storing the defective address location in the appropriate MRS register and logic 164, as described above. Thus, remapping of spare rows and spare columns internal may be performed both prior to the memory device 60 being placed in-service, as well as be performed after the memory device 60 has been placed in-service.

Among its other features, in accordance with example implementations, the memory device 60 includes an address register 106, which is coupled to receive an address indicated by corresponding signals on the address bus lines 106. The address register 108 provides the corresponding address to the control unit 70, a column address counter/latch 124, MRS register and logic units 164 and a row address multiplexer 120. The row address multiplexer 120 provides the rows to the appropriate row address latch and decoder 122 (one decoder 122 per memory bank 130), and the column address counter/latch 124 provides the column address to the appropriate column decoder 126 (one column decoder 126 per memory bank 130). The memory device 60 further includes bank control logic 112 to aid in the selection by the multiplexer 120 of the appropriate row address latch and decoder 122 and a refresh counter 114 to generate DRAM operations in the memory banks 130.

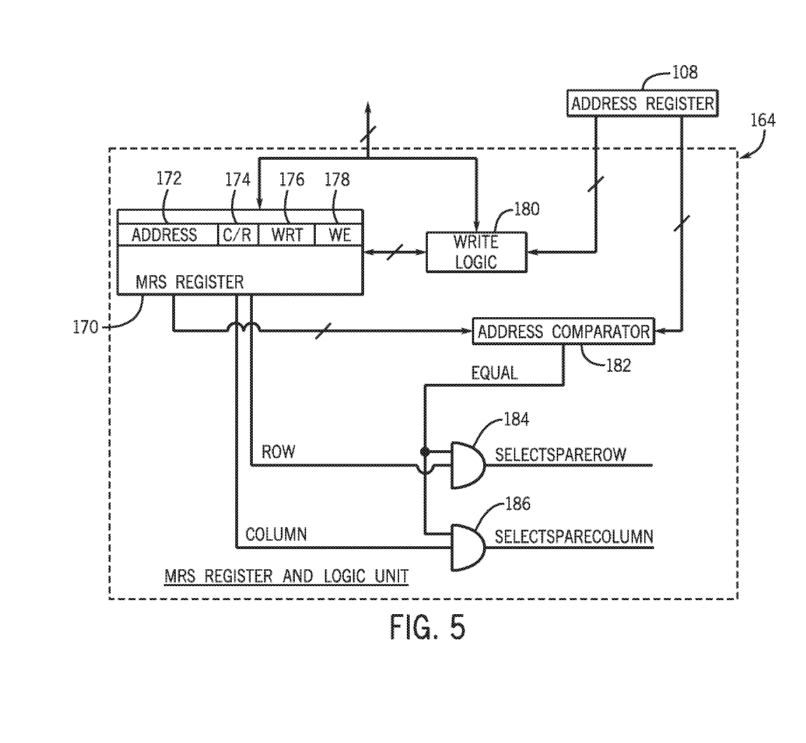

Referring to FIG. 5, in accordance with an example implementation, the MRS register and logic unit 164 includes at least one MRS register 170. In general, the MRS register 170 has an address field 172, which stores a defective memory address. This may be a row address or a column address, depending on the particular implementation. In this regard, a corresponding column/row (C/R) field 174 indicates whether the address in the address field 172 is a column address or a write address. Moreover, the MRS register 170 includes two bit fields 176 and 178, which are used for purposes of protecting the memory device 60 from a single bit programming/interface error due to an erroneous remapping operation. The bit fields 176 may also be used to allow a programmatic technique to enable a charge pump of the memory device 60 so that fusible structures may be selectively opened (as an example) on the memory device 60 to program in the defective memory address. For purposes of updating the MRS register 170, the MRS register and logic unit 164 includes write logic 180, in accordance with example implementations. In this regard, in accordance with some implementations, the write logic 180 may include the charge pump for purposes of allowing the non-volatile contents of the MRS register 170 to be updated upon receipt of the appropriate command at the control unit 70 or configuration interface 64.

The MRS register and logic unit 164 further includes an address comparator 182, which compares the address provided by the address register 108 with the address indicated by the address field 172 of the MRS register 170. The address comparator 182 provides a signal (called “EQUAL” in FIG. 5), which indicates the result of the comparison. In this regard, in accordance with an example implementation, when asserted, or driven to logic one, the EQUAL signal indicates that the defective address has been targeted on an operation to the semiconductor memory package 60. For a row (as indicated by a ROW signal), an AND gate 184 of the unit 164 asserts a signal (called “SELECTSPAREROW” in FIG. 5) to instruct the appropriate row address latch and decoder 122 (see FIG. 4) to select the spare row mapped to the address. Likewise, the MRS register and logic unit 164 includes an AND gate 186 that provides a signal (called “SELECTSPARECOLUMN” in FIG. 5), which is asserted, or driven to a logic one level for purposes of instructing the appropriate column decoder 126 to select a spare column for the current address. The AND gate 186 receives the EQUAL signal as well as the COLUMN signal.

It is noted that the schematic diagram of FIG. 5 is simplified for purposes of clarifying the operation of the MRS register and logic unit 164 for purposes of updating the MRS register 170 and using the address comparisons to enable swapping of a spare row or column with a corresponding row or column of the main array. It is noted that the MRS register and logic unit 164 may include various other components, depending on the particular implementation. For example, in accordance with some implementations, the AND gates 184 and 186 may receive signals, which may be selectively asserted and de-asserted for purposes of disabling the spare row and column selection. Thus, many implementations are contemplated, which are within the scope of the appended claims.

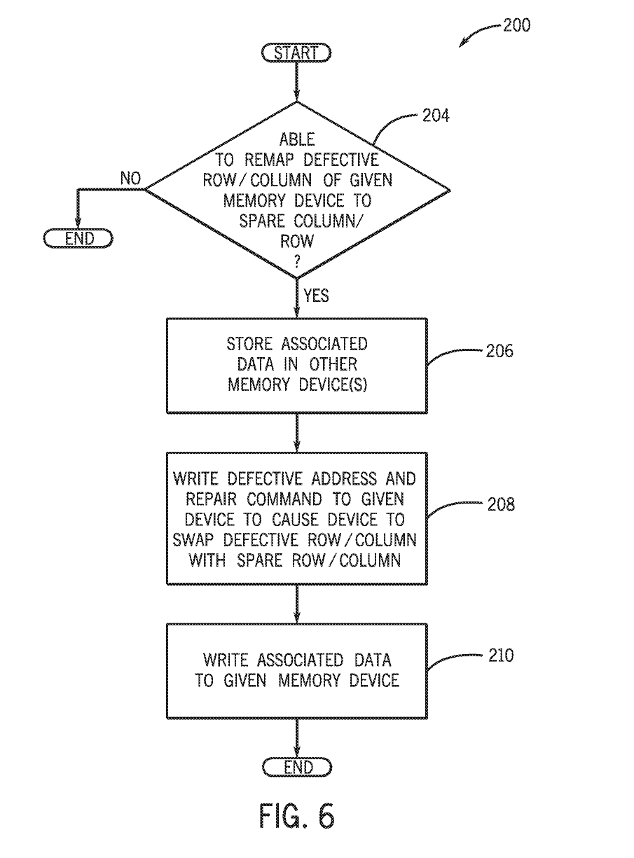

Referring to FIG. 6 in conjunction with FIG. 1, a flow diagram 200 (see FIG. 6) may be used by the CPU 20 (see FIG. 1), under the direction of the BIOS 34 (see FIG. 1), in response to the detection of one or more defective memory cells of a semiconductor memory package during the in-service use of the package. Pursuant to the technique 200, the CPU 20 determines (block 204) whether the defective column/row of a given memory package may be remapped to a spare column or row. If so, the affected data is first stored (block 206) in another memory package, i.e., stored outside of the memory package that is being repaired. Next, pursuant to the technique 200, the CPU 20 writes (block 208) the defective address and appropriate command to the memory package to cause the memory package to swap the defective row/column with the spare row/column. The CPU 20 then writes (block 210) the data temporarily stored outside of the repaired memory package to the memory package (which now employs the remapping due to the repair), pursuant to block 210:

It is noted that the data that is to be written to be repaired row is temporarily stored, as described above, to assure integrity of that data. If the platform supported a four bit symbol correction ECC algorithm (the ability to correct for any single DRAM failure) the data may not be temporarily stored, in accordance with an example implementation. However, even for platform supported four bit symbol correction ECC, the platform may be exposed to an uncorrectable event without the temporary storage if the memory device 60 or another memory device gives rise to a temporary error. Therefore, in accordance with a further example implementation, the temporary storage may be used with platform supported four bit symbol correction ECC. Thus, many variations are contemplated, which are within the scope of the appended claims.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
during a first in-service use of a memory package in a computer system, accessing a storage array of the memory device using a first interface of the memory device;
during a second in-service use of the memory device, using the first interface to access a defective address memory of the memory device, the defective address memory being accessible by a manufacturer of the memory device prior to the first and second in-service uses using a second interface other than the first interface; and
in connection with the access of the defective address memory using the first interface, repairing the memory device, the repairing comprising storing a defective address in the defective address memory to change an address mapping for at least one cell of the storage array.

2. The method of claim 1, further comprising:
using the storing of the defective address to map a defective column or a defective row of the storage array to a spare column or a spare row of the storage array.

3. The method of claim 1, wherein using the first interface to access the defective address memory comprises communicating a first command to the memory device using control lines used to communicate a second command to the memory device during the first in-service use.

4. The method of claim 1, wherein storing the defective address comprises storing the defective address in a register accessible by the manufacturer.

5. The method of claim 1, further comprising:
in connection with storing the defective address, storing an indication whether the defective address is associated with a column of the storage array or a row of the storage array.

6. The method of claim 1, further comprising:
using a basic input/output system of the computer system to access the defective address memory location and store the defective address in the defective address location.

7. The method of claim 1, further comprising:
identifying the defective memory location;
storing data associated with the defective memory location in a memory outside of the memory device; and
transferring the data from the memory outside of the memory device to the memory package after storing the defective address in the defective address location.

8. A computer system comprising:
a memory device comprising:
a storage array;
a group of at least one spare memory cell;
a defective address memory;
a first interface to access the storage array and access the defective address memory;
a second interface other than the first interface to allow a manufacturer to access the defective address before the memory device is placed in service; and
a processor to use the first interface to repair the memory device, the processor to access the defective address memory to store a defective address in the defective address memory to change an address mapping for at least one cell of the storage array to the at least one spare memory cell.

9. The system of claim 8, wherein the processor is adapted to the defective address to map a defective column or a defective row of the storage array to a spare column or a spare row of the storage array.

10. The system of claim 8, wherein first interface is coupled to control lines, and the first interface is adapted to decode a first command communicated to the first interface using the control lines to cause the memory device to access the storage array and decode a second command communicated to the first interface using the control lines to cause the memory device to store the defective address in the defective address memory.

11. The system of claim 8, wherein the defective address memory comprises a register accessible using the first interface and accessible using the second interface.

12. The system of claim 8, further comprising:
a basic input/output system to be executed by the processor to cause the processor to access the defective address memory location and store the defective address in the defective address location.

13. A memory device comprising:
a storage array;
a group of at least one spare memory cell;
a defective address memory;
a first interface to access the storage array to repair the memory device, the first interface to allow access to the defective address memory to store a defective address in the defective address memory to change an address mapping for at least one cell of the storage array to the at least one spare memory cell; and
a second interface other than the first interface to allow a manufacturer to access the defective address memory to repair the memory device before the memory device is placed in service.

14. The memory device of claim 13, wherein the memory device comprises a DDR SDRAM.

15. The memory device of claim 13, further comprising:
a semiconductor package containing the storage array, the group of at least one spare memory cell, the defective address memory, the first interface and the second interface; and
external contacts exposed outside of the semiconductor package, the external contacts comprises a first set of contacts to communicate a command to the first interface and a second set of contacts separate from the first set of contacts to communicate a command to the second interface.
